(19) United States
(12) Patent Application Publication
(10) Pub. No.: US 2025/0273032 A1
(43) Pub. Date: Aug. 28, 2025

(54) PAPER SHEET HANDLING APPARATUS AND METHOD FOR CONTROLLING PAPER SHEET HANDLING APPARATUS

(71) Applicants: FUJITSU FRONTECH LIMITED, Tokyo (JP); Fujitsu Frontech Systems Limited, Maebashi-shi (JP)

(72) Inventors: Satoshi HAYASHI, Inagi (JP); Toshiki SAJI, Inagi (JP); Tsuyoshi ABE, Inagi (JP); Masanori SATOU, Inagi (JP)

(73) Assignees: FUJITSU FRONTECH LIMITED, Inagi-shi, Tokyo (JP); Fujitsu Frontech Systems Limited, Maebashi-shi, Gunma (JP)

(21) Appl. No.: 19/209,077

(22) Filed: May 15, 2025

Related U.S. Application Data
(63) Continuation of application No. PCT/JP2022/042610, filed on Nov. 16, 2022.

(51) Int. Cl. G07D 11/237; G07D 11/26

(52) U.S. Cl. CPC G07D 11/237; G07D 11/26

(57) ABSTRACT

A paper sheet handling apparatus includes an upstream sensor and a downstream sensor arranged on an upstream side and a downstream side of the conveyance path respectively, and detect the paper sheet, and a controller that controls the drive mechanism based on detection results of the upstream sensor and the downstream sensor. In a case where the upstream sensor detects the paper sheet conveyed and then the paper sheet is not detected by the downstream sensor, the controller controls the drive mechanism to drive the conveyance path in a reverse direction opposite to the conveyance direction and to drive the conveyance path in the conveyance direction after the upstream sensor detects the paper sheet again, and the controller determines that a conveyance abnormality, which has occurred in a conveyance section between the upstream sensor and the downstream sensor, has been resolved when the downstream sensor detects the paper sheet.

### CROSS-REFERENCE TO RELATED APPLICATION

This application is a continuation application of International Application PCT/JP2022/042610, filed on Nov. 16, 2022 and designating the U.S., the entire contents of which are incorporated herein by reference.

### FIELD

The present invention relates to a paper sheet handling apparatus and a method for controlling the paper sheet handling apparatus.

### BACKGROUND

Examples of paper sheet handling apparatuses include a banknote handling apparatus such as an automated teller machine. This type of banknote handling apparatus includes one in which a plurality of sensors, disposed on a conveyance path on which a banknote is conveyed, detects occurrence of a banknote jam (hereinafter, also referred to as a jam) on the conveyance path. When a banknote jam occurs, the jam is resolved by driving the conveyance path to move and remove the stuck banknote or manually removing the stuck banknote.
Patent Literature 1: JP 2019-109644 A

In a case where a jam occurs on the conveyance path and it is impossible to convey a banknote detected by the sensor, the banknote handling apparatus described above can determine that the jam continues. However, in a case where the occurrence of the jam continues in a conveyance section between two sensors adjacent on the conveyance path, it is impossible to detect the presence or absence of the banknote remaining in the conveyance section. Then, it is determined that the jam has been resolved and the processing is normally terminated. This probably results in the loss of the remaining banknote. As described above, it is difficult for the banknote handling apparatus to detect that the jam in the conveyance section in which the jam has occurred has been reliably resolved. That is, the banknote handling apparatus is not capable of guaranteeing that the jam has been resolved in the conveyance section.

### SUMMARY

According to an aspect of the embodiments, a paper sheet handling apparatus includes: a conveyance path on which a paper sheet is conveyed; a drive mechanism that drives the conveyance path; an upstream sensor and a downstream sensor that are arranged on an upstream side and a downstream side of the conveyance path respectively in a conveyance direction of the paper sheet, and detect the paper sheet; and a controller that controls the drive mechanism based on detection results of the upstream sensor and the downstream sensor, wherein in a case where the upstream sensor detects the paper sheet conveyed in the conveyance direction and then the paper sheet is not detected by the downstream sensor, the controller controls the drive mechanism to drive the conveyance path in a reverse direction opposite to the conveyance direction and to drive the conveyance path in the conveyance direction after the upstream sensor detects the paper sheet again, and the controller determines that a conveyance abnormality, which has occurred in a conveyance section between the upstream sensor and the downstream sensor, has been resolved when the downstream sensor detects the paper sheet.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a configuration of a banknote handling apparatus according to an embodiment.

FIG. 2 is a longitudinal sectional view illustrating a conveyance path of the banknote handling apparatus according to the embodiment.

FIG. 3 is a flowchart illustrating control processing by a controller in the embodiment.

FIG. 4A is a schematic diagram illustrating detection of a jam in a conveyance section in the embodiment.

FIG. 4B is a schematic diagram illustrating detection of a jam in a conveyance section in the embodiment.

FIG. 4C is a schematic diagram illustrating detection of jam resolution in a conveyance section in the embodiment.

FIG. 4D is a schematic diagram illustrating detection of jam resolution in a conveyance section in the embodiment.

### DESCRIPTION OF EMBODIMENTS

Hereinafter, an embodiment of a paper sheet handling apparatus and a method for controlling the paper sheet handling apparatus disclosed in the present application, will be described in detail with reference to the drawings. Note that the following embodiment does not limit the paper sheet handling apparatus and the method for controlling the paper sheet handling apparatus disclosed in the present application.

### Embodiments

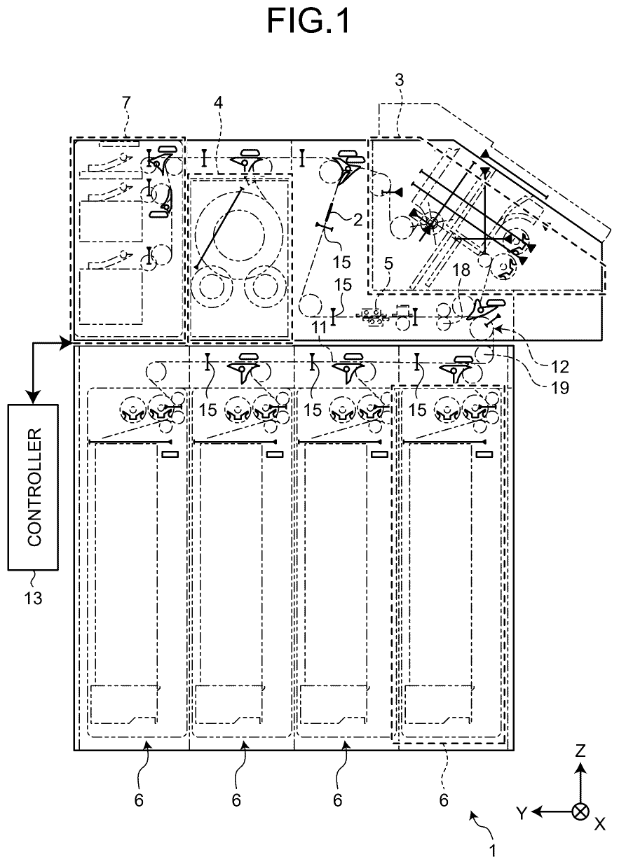

FIG. 1 is a schematic diagram illustrating a configuration of a banknote handling apparatus according to an embodiment. As illustrated in FIG. 1, a banknote handling apparatus 1 according to the embodiment includes a receiving/dispensing unit 3 that receives and dispenses a banknote 2, a temporary storage unit 4 that temporarily stores the banknote 2 received by the receiving/dispensing unit 3, a discriminating unit 5 that discriminates the banknote 2 conveyed from the temporary storage unit 4, a plurality of return units (storage units) 6 that stores and dispenses the banknote 2, conveyed from the discriminating unit 5, to return the banknote 2, and a rejection unit 7 that stores the banknote 2 having an abnormal thickness or length or the banknote 2 deteriorated (damaged).

The banknote handling apparatus 1 further includes a conveyance path 11 on which the banknote 2 is conveyed between the units 3 to 7, a drive mechanism 12 that drives the conveyance path 11, and a controller 13 that controls the drive mechanism 12.

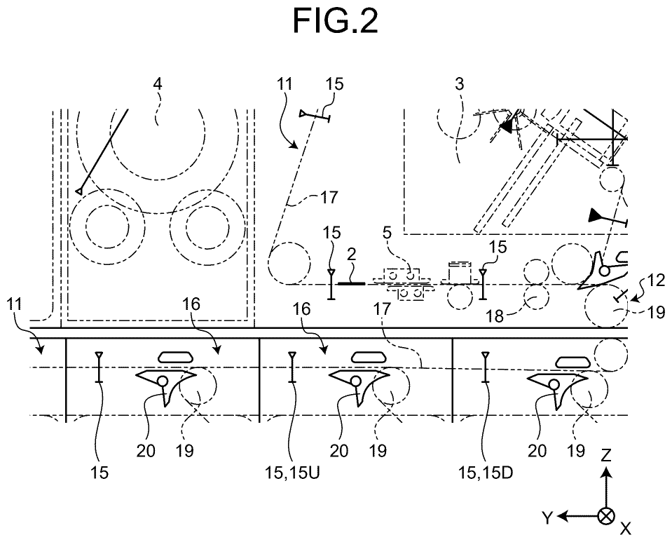

For convenience of description, in FIG. 1, when the banknote handling apparatus 1 is viewed from the receiving/dispensing unit 3 side, a width direction of the banknote handling apparatus 1 is referred to as an X direction, a front-rear direction of the banknote handling apparatus 1 is referred to as a Y direction, and a top-bottom direction of the banknote handling apparatus 1 is referred to as a Z direction. Similarly to FIG. 1, X, Y, and Z directions are illustrated also in FIG. 2. In the present embodiment, the banknote 2 is used as an example of a paper sheet, but the paper sheet is not limited to the banknote 2. The paper sheet includes, for example, securities such as a draft, a check, a gift certificate, various securities, and a stock certificate.

### (Conveyance Path)

The conveyance path 11 of the banknote handling apparatus 1 is configured as a bidirectional conveyance path on which the banknote 2 can be bidirectionally conveyed, except for the conveyance path 11 used to store the banknote 2 into the rejection unit 7. FIG. 2 is a longitudinal sectional view illustrating the conveyance path 11 of the banknote handling apparatus 1 according to the embodiment, and is a longitudinal sectional view illustrating an example of the bidirectional conveyance path in the banknote handling apparatus 1.

As illustrated in FIG. 2, a plurality of sensors 15 for detecting the passage of the banknote 2 is arranged on the conveyance path 11 at intervals along the conveyance direction of the banknote 2. A conveyance section 16 is formed between the two sensors 15 adjacent on the conveyance path 11, that is, between an upstream sensor 15U and a downstream sensor 15D in the conveyance direction of the banknote 2, and the conveyance path 11 includes the plurality of conveyance sections 16.

As the sensor 15, for example, a reflective optical sensor or a transmissive optical sensor is used. Each of the sensors 15 is electrically connected to the controller 13, and transmits a detection signal to the controller 13. The controller 13 is electrically connected to the drive mechanism 12, and controls the drive mechanism 12 based on a detection result of each of the sensors 15.

In addition, the conveyance path 11 includes a conveyor belt 17 and a conveyor roller 18 that convey the banknote 2, a pulley 19 that drives the conveyor belt 17, and a switching member 20 that switches the conveyance path 11 so as to send the banknote 2 to the individual units 3 to 7 described above. The drive mechanism 12 sends the conveyor belt 17 in one direction or another direction opposite to that one direction by rotating the pulley 19 forward or backward, so that the banknote 2 is conveyed in both directions along the conveyance path 11.

### (Control Processing of Controller)

The following description is provided of control processing in which, when a jam of the banknote 2 occurs in the conveyance path 11, the controller 13 of the banknote handling apparatus 1 detects the resolution of the jam that is a conveyance abnormality, that is, determines whether the jam has been resolved.

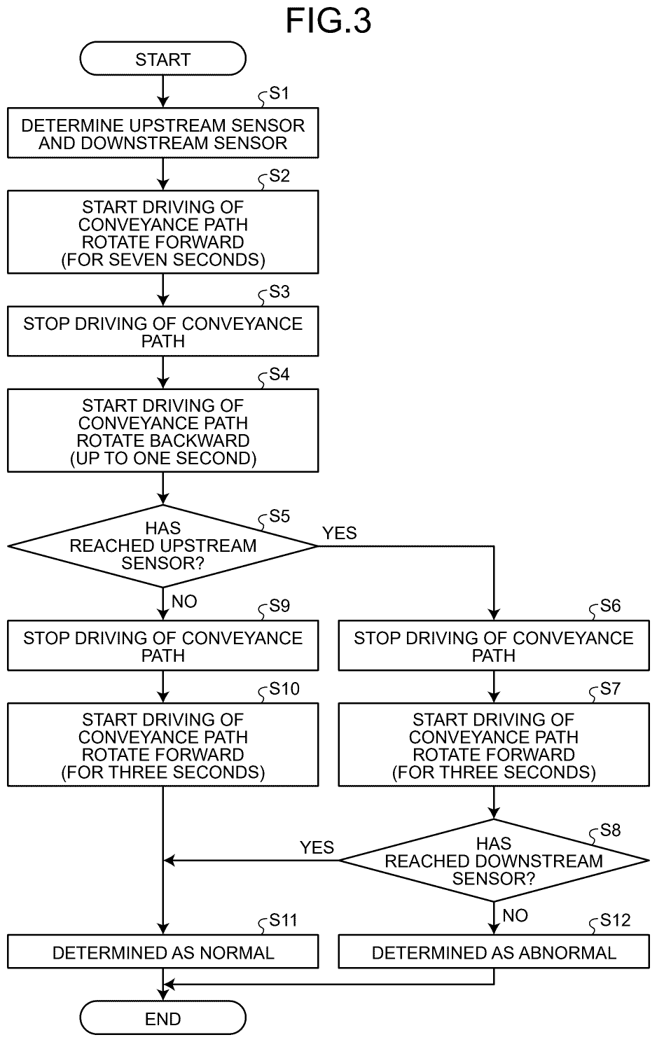

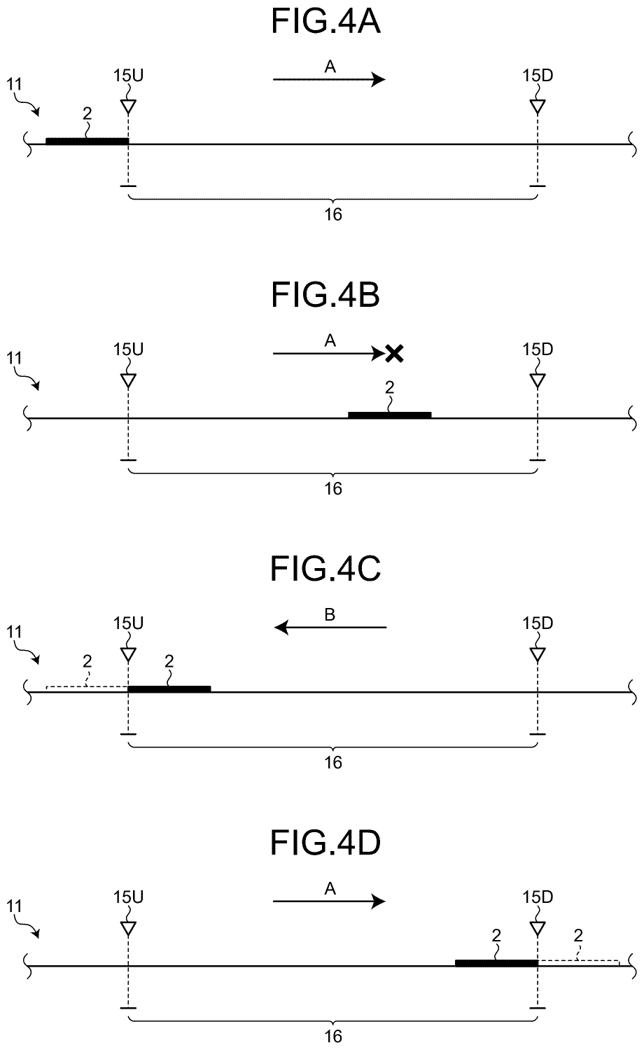

FIG. 3 is a flowchart illustrating control processing of the controller 13 in the embodiment. FIGS. 4A and 4B are schematic diagrams illustrating detection of a jam in the conveyance section 16 in the embodiment. FIGS. 4C and 4D are schematic diagrams illustrating detection of jam resolution in the conveyance section 16 in the embodiment.

The controller 13 of the banknote handling apparatus 1 monitors the presence or absence of a jam of the banknote 2 in the plurality of conveyance sections 16 on the conveyance path 11 based on the detection result of each of the sensors 15. As illustrated in FIGS. 4A and 4B, in a case where the upstream sensor 15U of the plurality of sensors 15 detects the banknote 2 and then the banknote 2 is not detected by the downstream sensor 15D, the controller 13 determines that a jam of the banknote 2 has occurred in the conveyance section 16 between the upstream sensor 15U and the downstream sensor 15D.

As illustrated in FIG. 3, the controller 13 determines, from among the plurality of sensors 15, the upstream sensor 15U and the downstream sensor 15D as the two sensors 15 adjacent in the conveyance direction A (Step S1) to thereby identify any conveyance section 16 among the plurality of conveyance sections 16.

The controller 13 starts driving the conveyance path 11 for the conveyance section 16 in which the jam has occurred, and controls the drive mechanism 12 to drive the conveyance path 11 in the conveyance direction A in which the banknote 2 is sent from the upstream sensor 15U to the downstream sensor 15D (Step S2). At this time, the controller 13 drives the conveyance path 11 in the conveyance direction A for a predetermined time T1, for example, seven seconds, by rotating the pulley 19 of the drive mechanism 12 forward. Here, the predetermined time T1 for driving the conveyance path 11 in the conveyance direction A is a time during which an attempt is made to forcibly convey the jammed banknote 2 in the conveyance direction A. For example, as the predetermined time T1, a time sufficiently longer than a time during which the banknote 2 can be conveyed from the upstream sensor 15U to the downstream sensor 15D, is secured.

In this manner, the controller 13 attempts to clear the jam by forcibly sending the jammed banknote 2 in the conveyance section 16 in the conveyance direction A. At this time, in a case where the jammed banknote 2 is detected by the downstream sensor 15D, the controller 13 determines that the jam has been cleared.

After driving the conveyance path 11 in the conveyance direction A for the predetermined time T1, the controller 13 stops driving the conveyance path 11 (Step S3). Subsequently, the controller 13 starts driving the conveyance path 11 for the conveyance section 16 in which the jam has occurred, and as illustrated in FIG. 4C, controls the drive mechanism 12 to drive the conveyance path 11 in a direction B, which is opposite to the conveyance direction A, from the downstream sensor 15D to the upstream sensor 15U (Step S4). Thereby, the controller 13 attempts to return the jammed banknote 2 in the conveyance section 16 to the upstream sensor 15U. At this time, the controller 13 drives the conveyance path 11 in the reverse direction B for a predetermined time T2, for example, up to one second, by rotating the pulley 19 of the drive mechanism 12 backward. Here, the predetermined time T2 for driving the conveyance path 11 in the reverse direction B, is a time during which the jammed banknote 2 can be sent in the reverse direction B, and is set according to, for example, the conveying speed of the conveyance path 11 and the length of the conveyance section 16.

The controller 13 determines whether the banknote 2, which is conveyed in the reverse direction B on the conveyance path 11, has reached the upstream sensor 150, based on a detection result of the upstream sensor 15U (Step S5). In a case where the upstream sensor 15U detects the banknote 2 again in Step S5 (Yes), the controller 13 stops driving the conveyance path 11 (Step S6). Here, detecting again refers to the second detection subsequent to the detection of the banknote 2 by the upstream sensor 15U immediately before the controller 13 detects the jam.

Subsequently, the controller 13 starts driving the conveyance path 11 for the conveyance section 16, and, as illustrated in FIG. 4D, controls the drive mechanism 12 to drive the conveyance path 11 in the conveyance direction A in which the banknote 2 is sent from the upstream sensor 15U to the downstream sensor 15D (Step S7). At this time, the controller 13 drives the conveyance path 11 in the conveyance direction A for a predetermined time T3, for example, three seconds, by rotating the pulley 19 of the drive mechanism 12 forward. Here, as for the predetermined time T3 for driving the conveyance path 11 in the conveyance direction A, for example, a time sufficiently longer than a time during which the banknote 2 can be conveyed from the upstream sensor 15U to the downstream sensor 15D, is secured.

Subsequently, the controller 13 determines whether the banknote 2, which is conveyed in the conveyance direction A on the conveyance path 11, has reached the downstream sensor 15D, based on a detection result of the downstream sensor 15D (Step S8). In a case where the downstream sensor 15D detects the banknote 2 in Step S8 (Yes), the controller 13 determines that the jam in the conveyance section 16 has been cleared and the conveyance section 16 is normal (the conveyance abnormality has been resolved) (Step S11), and finishes the control processing for resolving the jam. On the other hand, in a case where the downstream sensor 15D does not detect the banknote 2 in Step S8 (No), the controller 13 determines an abnormality that the jammed banknote 2 remains in the conveyance section 16 (the conveyance abnormality continues) (Step S12), and finishes the control processing for resolving the jam. At this time, the controller 13 warns an operator or the like that the conveyance abnormality in the conveyance section 16 still continues, for example, through a not illustrated display unit or the like included in the banknote handling apparatus 1, and urges the operator or the like to perform maintenance work such as manually removing the jammed banknote 2.

In a case where the upstream sensor 15U does not detect the banknote 2 again in Step S5 (No), the controller 13 stops driving the conveyance path 11 (Step S9). Subsequently, the controller 13 starts driving the conveyance path 11 for the conveyance section 16, and controls the drive mechanism 12 to drive the conveyance path 11 in the conveyance direction A in which the banknote 2 is sent from the upstream sensor 15U to the downstream sensor 15D (Step S10). At this time, the controller 13 drives the conveyance path 11 in the conveyance direction A for a predetermined time T4, for example, three seconds, by rotating the pulley 19 of the drive mechanism 12 forward. Here, as for the predetermined time T4 for driving the conveyance path 11 in the conveyance direction A, for example, a time sufficiently longer than a time during which the banknote 2 can be conveyed from the upstream sensor 15U to the downstream sensor 15D, is secured.

In a case where the upstream sensor 15U does not detect the banknote 2 again in Step S5 (No), the controller 13 determines that the jammed banknote 2 has been manually removed from the conveyance section 16 by maintenance work. Therefore, the controller 13 determines that the jam in the conveyance section 16 has been cleared and the conveyance section 16 is normal (Step S11), and finishes the control processing for resolving the jam.

Then, the controller 13 performs the control processing as described above on the conveyance section 16 between the two adjacent sensors 15 (upstream sensor 15U and downstream sensor 15D) among the plurality of sensors 15 arranged on the conveyance path 11, which enables a determination of whether the jam in the plurality of conveyance sections 16 has been resolved. That is, the controller 13 can guarantee that the jam has been resolved for the plurality of conveyance sections 16 in which the jam has occurred.

In the control processing (Steps S5 and S6) described above, as an example, when the upstream sensor 15U detects the rear end of the banknote 2 conveyed in the reverse direction B, the controller 13 stops driving the conveyance path 11. However, another configuration is possible in which when the upstream sensor 15U detects that the front end of the banknote 2, which is conveyed in the reverse direction B, has passed through the upstream sensor 15U, the controller 13 stops driving the conveyance path 11. Similarly, in the control processing (Step S8) described above, as an example, when the downstream sensor 15D detects the front end of the banknote 2, which is conveyed in the conveyance direction A, the controller 13 determines that the jam has been cleared. However, another configuration is possible in which when the downstream sensor 15D detects that the rear end of the banknote 2, which is conveyed in the conveyance direction A, has passed through the downstream sensor 15D, the controller 13 determines that the jam has been cleared.

### (Method for Controlling Banknote Handling Apparatus)

In the method for controlling the banknote handling apparatus 1, in a case where the upstream sensor 15U detects the banknote 2, conveyed on the conveyance path 11 in the conveyance direction A, and then the banknote 2 is not detected by the downstream sensor 15D, the controller 13 controls the drive mechanism 12 to drive the conveyance path 11 in the reverse direction B opposite to the conveyance direction A, and to drive the conveyance path 11 in the conveyance direction A after the upstream sensor 15U detects the banknote 2 again, and the controller 13 determines that the jam (conveyance abnormality) of the banknote 2, which has occurred in the conveyance section 16 between the upstream sensor 15U and the downstream sensor 15D, has been resolved when the downstream sensor 15D detects the banknote 2.

### Effects of Embodiments

As described above, the banknote handling apparatus 1 according to the embodiment includes the conveyance path 11 on which the banknote 2 is conveyed, the drive mechanism 12 that drives the conveyance path 11, the upstream sensor 15U and the downstream sensor 15D that are disposed on the upstream side and the downstream side of the conveyance path 11 respectively in the conveyance direction A of the banknote 2 and detect the banknote 2, and the controller 13 that controls the drive mechanism 12 based on the detection results of the upstream sensor 15U and the downstream sensor 15D. In a case where the upstream sensor 15U detects the banknote 2, which is conveyed in the conveyance direction A, and then the banknote 2 is not detected by the downstream sensor 15D, the controller 13 controls the drive mechanism 12 to drive the conveyance path 11 in the reverse direction B opposite to the conveyance direction A, and to drive the conveyance path 11 in the conveyance direction A after the upstream sensor 15U detects the banknote 2 again, and the controller 13 determines that the jam, which has occurred in the conveyance section 16 between the upstream sensor 15U and the downstream sensor 15D, has been resolved when the downstream sensor 15D detects the banknote 2. As a result, the banknote handling apparatus 1 can guarantee that the jam in the conveyance section 16, in which the jam has occurred on the conveyance path 11, has been resolved. In other words, the banknote handling apparatus 1 can determine whether the jam has been resolved in the conveyance section 16 in which the jam has occurred, and can detect that the jam in the conveyance section 16 has been reliably resolved.

As described above, the banknote handling apparatus 1 according to the embodiment is not characterized by operation of resolving a jam by driving the conveyance path 11 in the backward direction and the forward direction, but is characterized by detecting the resolution of a jam in the conveyance section 16 between the upstream sensor 15U and the downstream sensor 15D, that is, by determining whether a jam has been resolved, and is characterized by guaranteeing the resolution of a jam in the conveyance section 16.

Further, in a case where the conveyance path 11 is driven in the reverse direction B opposite to the conveyance direction A and the upstream sensor 15U detects the banknote 2 again and then the conveyance path 11 is driven in the conveyance direction A for the predetermined time T3 and the banknote 2 is not detected by the downstream sensor 15D, the controller 13 of the banknote handling apparatus 1 according to the embodiment determines that the conveyance abnormality continues in the conveyance section 16. As describe above, in a case where an attempt to resolve the jam is made by driving the conveyance path 11 in the conveyance direction A for the predetermined time T3 to forcibly send the jammed banknote 2 in the conveyance direction A, and the jam is not resolved for the predetermined time T3, it is determined that the jam continues, which makes it possible to smoothly urge maintenance work such as manually removing the jammed banknote 2.

Further, in a case where the upstream sensor 15U detects the banknote 2, which is conveyed in the conveyance direction A, and then the banknote 2 is not detected by the downstream sensor 15D, and in a case where the conveyance path 11 is driven in the conveyance direction A for the predetermined time T1 and the banknote 2 is not detected by the downstream sensor 15D, the controller 13 of the banknote handling apparatus 1 according to the embodiment controls the drive mechanism 12 to drive the conveyance path 11 in the reverse direction B opposite to the conveyance direction A. As describe above, in a case where an attempt to resolve the jam is made by driving the conveyance path 11 in the conveyance direction A for the predetermined time T1 to forcibly send the jammed banknote 2 in the conveyance direction A, and the jam is not resolved for the predetermined time T1, the conveyance path 11 is driven in the reverse direction B, which makes it possible to resolve the jam that can be easily resolved and to promptly determine whether the jam has been resolved in the conveyance section 16.

In addition, the banknote handling apparatus 1 according to the embodiment includes the plurality of sensors 15 that is arranged at intervals in the conveyance direction A on the conveyance path 11 and detects the banknote 2, and the controller 13 determines whether a conveyance abnormality has been resolved in the plurality of conveyance sections 16 by controlling the drive mechanism 12 using, as the upstream sensor 15U and the downstream sensor 15D, the two sensors 15 adjacent in the conveyance direction A among the plurality of sensors 15 based on the detection result of each of the plurality of sensors 15. As described above, the banknote handling apparatus 1 can determine whether a jam in each of the plurality of conveyance sections 16 on the conveyance path 11 has been resolved.

According to one aspect of the paper sheet handling apparatus disclosed in the present application, it is possible to detect that a paper sheet jam has been resolved in a conveyance section in which the jam has occurred.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet handling apparatus comprising:
a conveyance path on which a paper sheet is conveyed;
a drive mechanism that drives the conveyance path;
an upstream sensor and a downstream sensor that are arranged on an upstream side and a downstream side of the conveyance path respectively in a conveyance direction of the paper sheet, and detect the paper sheet; and
a controller that controls the drive mechanism based on detection results of the upstream sensor and the downstream sensor, wherein
in a case where the upstream sensor detects the paper sheet conveyed in the conveyance direction and then the paper sheet is not detected by the downstream sensor, the controller controls the drive mechanism to drive the conveyance path in a reverse direction opposite to the conveyance direction and to drive the conveyance path in the conveyance direction after the upstream sensor detects the paper sheet again, and the controller determines that a conveyance abnormality, which has occurred in a conveyance section between the upstream sensor and the downstream sensor, has been resolved when the downstream sensor detects the paper sheet.

2. The paper sheet handling apparatus according to claim 1, wherein
the controller determines that the conveyance abnormality continues in the conveyance section, in a case where the conveyance path is driven in the reverse direction opposite to the conveyance direction and the upstream sensor detects the paper sheet again and then the conveyance path is driven in the conveyance direction for a predetermined time and the paper sheet is not detected by the downstream sensor.

3. The paper sheet handling apparatus according to claim 1, wherein
the controller controls the drive mechanism to drive the conveyance path in the reverse direction opposite to the conveyance direction, in a case where the upstream sensor detects the paper sheet conveyed in the conveyance direction and then the paper sheet is not detected by the downstream sensor, and in a case where the conveyance path is driven in the conveyance direction for a predetermined time and the paper sheet is not detected by the downstream sensor.

4. The paper sheet handling apparatus according to claim 1, further comprising
a plurality of sensors that is arranged at intervals in the conveyance direction on the conveyance path and detects a paper sheet, wherein
the controller determines whether a conveyance abnormality has been resolved in a plurality of conveyance sections by controlling the drive mechanism using, as the upstream sensor and the downstream sensor, two sensors adjacent in the conveyance direction among the plurality of sensors based on a detection result of each of the plurality of sensors.

5. A method for controlling a paper sheet handling apparatus, the paper sheet handling apparatus including a conveyance path on which a paper sheet is conveyed; a drive mechanism that drives the conveyance path; an upstream sensor and a downstream sensor that are arranged on an upstream side and a downstream side of the conveyance path respectively in a conveyance direction of the paper sheet, and detect the paper sheet; and a controller that controls the drive mechanism based on detection results of the upstream sensor and the downstream sensor, the method comprising:
controlling, by the controller, the drive mechanism to drive the conveyance path in a reverse direction opposite to the conveyance direction and to drive the conveyance path in the conveyance direction after the upstream sensor detects the paper sheet again in a case where the upstream sensor detects the paper sheet conveyed in the conveyance direction and then the paper sheet is not detected by the downstream sensor; and
determining, by the controller, that a conveyance abnormality, which has occurred in a conveyance section between the upstream sensor and the downstream sensor, has been resolved when the downstream sensor detects the paper sheet.
